(19) United States
(12) Patent Application Publication
(10) Pub. No.: US 2016/0299946 A1
(43) Pub. Date: Oct. 13, 2016

(54) Usage and Symptom Oriented SQL Statement Optimization

(71) Applicant: Dell Software, Inc., Round Rock, TX (US)

(72) Inventors: Wai Yip To, Yaumatei (HK); Ka Wing Luk, Tseung Kwan O (HK)

(73) Assignee: DELL SOFTWARE, INC., Round Rock, TX (US)

(21) Appl. No.: 14/683,416

(22) Filed: Apr. 10, 2015

(51) Int. Cl. G06F 17/30

(52) U.S. Cl. CPC G06F 17/30448; G06F 17/30306; G06F 17/30404

(57) ABSTRACT

A system, method, and computer-readable medium are disclosed for providing usage and symptom oriented SQL statement optimization. More specifically, in certain embodiments, a SQL Optimizer is provided with a SQL Statement Usage and Symptom Oriented Tuning Tool. More specifically, the SQL Statement Usage and Symptom Oriented Tuning Tool assists users in composing a correct test run method and selecting a correct resource saving item. Additionally, in certain embodiments, the SQL Statement Usage and Symptom Oriented Tuning Tool includes a tuning tool user interface which allows users to provide the tool with specific information about the performance symptoms and usage patterns of their SQL statement. By providing such a user interface, users do not need to have knowledge of the actual settings used to tune the SQL statement. The SQL Statement Usage and Symptom Oriented Tuning Tool automatically composes settings to provide a SQL statement test run method on behalf of the user.

### BACKGROUND OF THE INVENTION

1. Field of the Invention

The present invention relates to information handling systems. More specifically, embodiments of the invention relate to usage and symptom oriented SQL STATEMENT optimization.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to execute structured query language (SQL) statements on information handling systems to access and interact with a database, the combination of which is generally referred to as a SQL system. SQL is a special-purpose programming language designed for managing data held in a relational database management system (RDBMS), or for stream processing in a relational data stream management system (RDSMS). It is known to tune the operation of a SQL system using SQL tuning tools. Tuning a SQL system describes a group of activities used to optimize and homogenize the performance of a SQL database. One aspect of tuning includes query tuning on a particular SQL statement.

Known SQL statement tuning tools aim to improve SQL system speed by providing multiple options for users to specify a particular resource to save or freely compose a benchmark method to solve a specific performance problem. While this approach is often flexible in covering different scenarios, the approach is sometimes not able to address the real need of users directly. For example, some SQL statement problems only happen in certain situations and users may need to identify a solution in which the SQL's performance is balanced in both the problematic and normal situations. Solving such a problem might require users to have in-depth knowledge about all the different test run methods before they can configure a benchmarking method to locate a best-fit solution. So instead of resolving problems straightforwardly, the approach can require users to first translate their problems into a group of test run methods. For example, FIG. 1, labeled Prior Art, shows a list of benchmark methods that are available in a product available from Dell Computer under the trade designation Dell SQL Optimizer.

### SUMMARY OF THE INVENTION

A system, method, and computer-readable medium are disclosed for providing usage and symptom oriented SQL statement optimization. More specifically, in certain embodiments, a SQL Optimizer is provided with a SQL Statement Usage and Symptom Oriented Tuning Tool. More specifically, the SQL Statement Usage and Symptom Oriented Tuning Tool assists users in composing a correct test run method and selecting a correct resource saving item. Additionally, in certain embodiments, the SQL Statement Usage and Symptom Oriented Tuning Tool includes a tuning tool user interface which allows users to provide the tool with specific information about the performance symptoms and usage patterns of their SQL statement. By providing such a user interface, users do not need to have knowledge of the actual settings used to tune the SQL statement. The SQL Statement Usage and Symptom Oriented Tuning Tool automatically composes settings to provide a SQL statement test run method on behalf of the user.

Such a tuning tool minimizes the complexity of setting up test run options and allows users to define their problems directly. Such a tuning tool also converts complicated SQL statement tuning scenarios into simplified questions without requiring users to have in-depth SQL tuning knowledge. As a result, users can quickly and efficiently locate a best solution for their specific problem.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1, labeled Prior Art, shows a list of benchmark methods that are available in a known SQL Optimizer.

FIG. 2 shows a general illustration of components of an information handling system as implemented in the system and method of the present invention.

FIG. 3 shows a block diagram of the SQL Statement Usage and Symptom Oriented Tuning Tool.

FIG. 4 shows a flow chart of the operation of a SQL Statement Usage and Symptom Oriented Tuning Tool.

FIG. 5 shows an example screen presentation of the tuning tool user interface.

FIG. 6 shows a block diagram of rules of an expert system of the SQL Statement Usage and Symptom Oriented Tuning Tool.

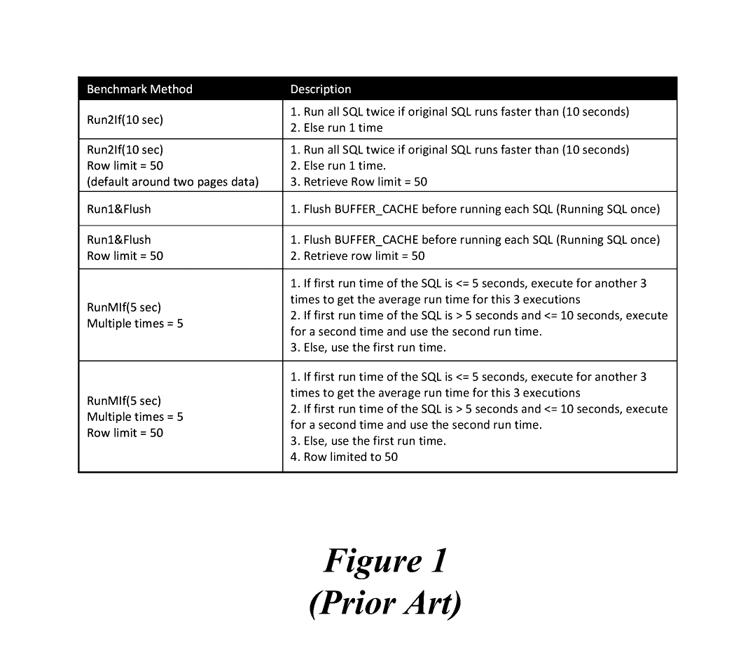

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

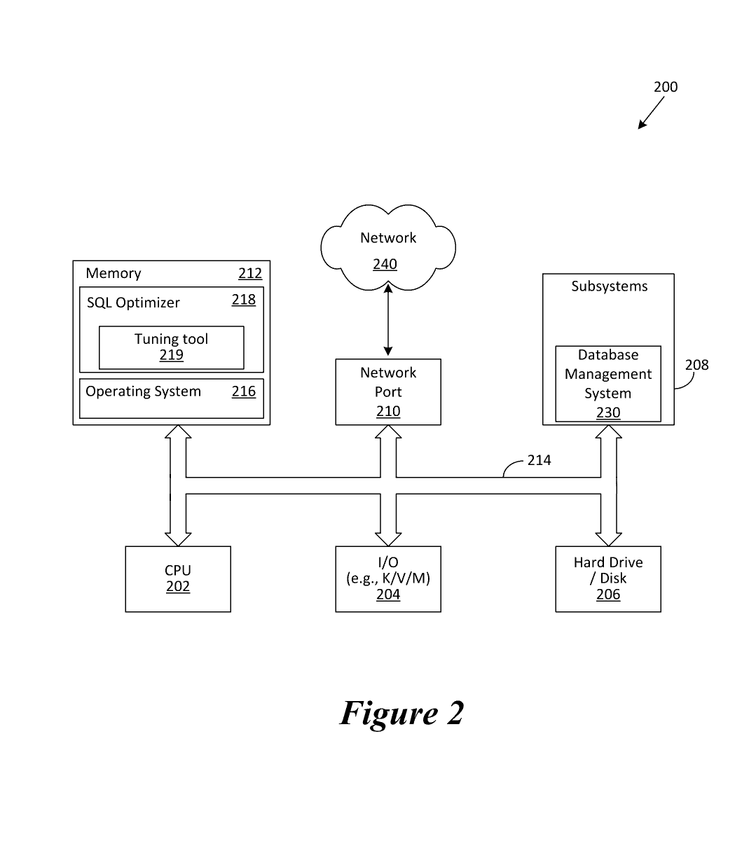

FIG. 2 is a generalized illustration of an information handling system 200 that can be used to implement the system and method of the present invention. The information handling system 200 includes a processor (e.g., central processor unit or “CPU”) 202, input/output (PO) devices 204, such as a display, a keyboard, a mouse, and associated controllers, a hard drive or disk storage 206, and various other subsystems 208. In various embodiments, the information handling system 200 also includes network port 210 operable to connect to a network 240. The information handling system 200 likewise includes system memory 212, which is interconnected to the foregoing via one or more buses 214. System memory 212 further comprises operating system (OS) 216 and in various embodiments may also comprise a SQL Optimizer module 218, which includes a SQL Statement Usage and Symptom Oriented Tuning Tool 219. Also, in certain embodiments, the information handling system also includes a database management system 230.

The SQL Optimizer enables SQL optimization. More specifically, in certain embodiments, the SQL Statement Usage and Symptom Oriented Tuning Tool 219 assists users in composing a correct test run method and selecting a correct resource saving item. Additionally, in certain embodiments, the SQL Statement Usage and Symptom Oriented Tuning Tool 219 includes a tuning tool user interface which allows users to provide the tool with specific information about the performance symptoms and usage patterns of their SQL statements. By providing such a tuning tool user interface, users do not need to have knowledge of the actual settings used to tune the SQL statements. The SQL Statement Usage and Symptom Oriented Tuning Tool automatically composes settings to provide a SQL statement test run method on behalf of the user.

Such a tuning tool minimizes the complexity of setting up test run options and allows users to define their problems directly. Such a tuning toot also converts complicated SQL statement tuning scenarios into simplified questions without requiring users to have in-depth SQL statement tuning knowledge. As a result, users can quickly and efficiently locate a best solution for their specific problem.

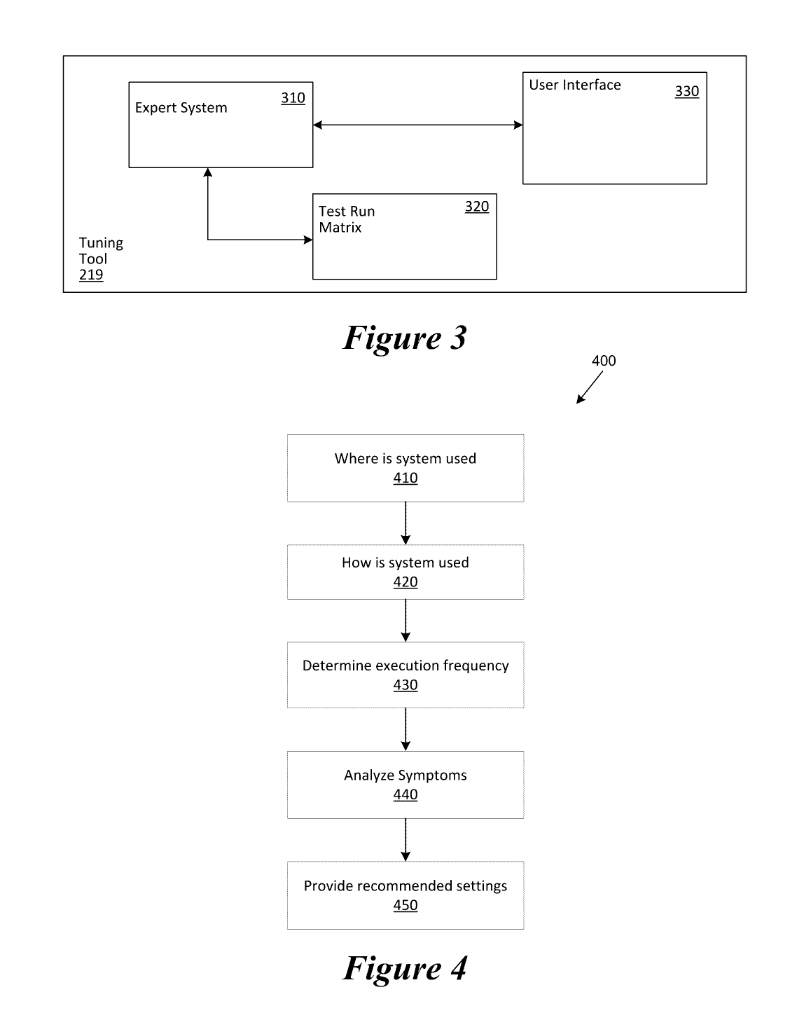

Referring to FIG. 3 a block diagram of the SQL Statement Usage and Symptom Oriented Tuning Tool 219 is shown. The SQL Statement Usage and Symptom Oriented Tuning Tool 219 includes an expert system module 310, a test run matrix module 320, as welt as a tuning tool user interface module 330. The expert system module 310 interacts with the test run matrix module 320 to compose benchmark methods on behalf of the users. Instead of showing users a list of different test run options (e.g. “Execute SQL once”, “Flush BUFFER_CACHE before executing the SQL”, etc.) which the users might need to learn to use, the tuning tool user interface module 330 presents an input screen which allows users to define the usage pattern and symptom of the SQL statements. Such a tuning tool 219 allows users who do not have knowledge about how to define SQL statement benchmark methods based on their SQL statement usage pattern and performance symptoms to compose benchmark methods.

FIG. 4 shows a flow chart of the operation of a SQL Statement Usage and Symptom Oriented Tuning Tool 219. The SQL Statement Usage and Symptom Oriented Tuning Tool 219 allows users to define symptoms to their problems and have the tuning tool provide solutions to the problems as compared to having users translating problems into a number of options which are provided to tuning and benchmarking options to arrive at solutions. In certain embodiments, the expert system 310 interacts with test matrix 320 and the user interface 330 when performing some or all of the operation steps.

More specifically, at step 410, the tuning tool 219 analyzes where the SQL statement is used. Next at step 420, the tuning tool 219 analyzes how the SQL statement is used. Next, at step 430, the tuning tool 219 determines an execution frequency of the SQL statement. Next at step 440, the tuning tool 219 analyzes any symptoms of the SQL statement. Next, at step 450, the tuning tool 219 provides recommended settings to address any issues identified by the tuning tool 219.

More specifically, when analyzing where the SQL statement is used at step 410, the SQL statement may be used in a report or batch where all records are retrieved from the SQL system, the SQL statement may be used in an online query program where normally less than 100 records are retrieved for review, but all records may also be retrieved, the SQL statement may be used in an online query program where normally only a specified number of rows are retrieved. When analyzing how the SQL statement is used at step 420, the SQL statement may be executed within a Procedural Language/Structured Query Language (PL/SQL) block, the SQL statement may be executed as a dynamic SQL statement sent from an application program or the answer may be undefined or all of the options. When determining an execution frequency at step 430, the execution frequency may be low, e.g., a few times a day, medium, e.g., a few times within a minute or hour, high, e.g., hundreds of times or more a minute or either unknown or of varying frequency. When analyzing the symptoms of the SQL statement at step 440, the SQL statement may consume a large amount of processor power or a user may desire saving processor power, the SQL statement may consume a large amount of input/output (IO) cycles on the system or the user may desire saving of IO cycles, the SQL statement may run longer than expected or the user may desire an improvement in execution time, the SQL statement may significantly affect the performance of other SQL statements in the system, or the SQL statement may execute slowly during a first execution of the day and the user may wish to optimize the SQL statement for a scenario where not data is cached.

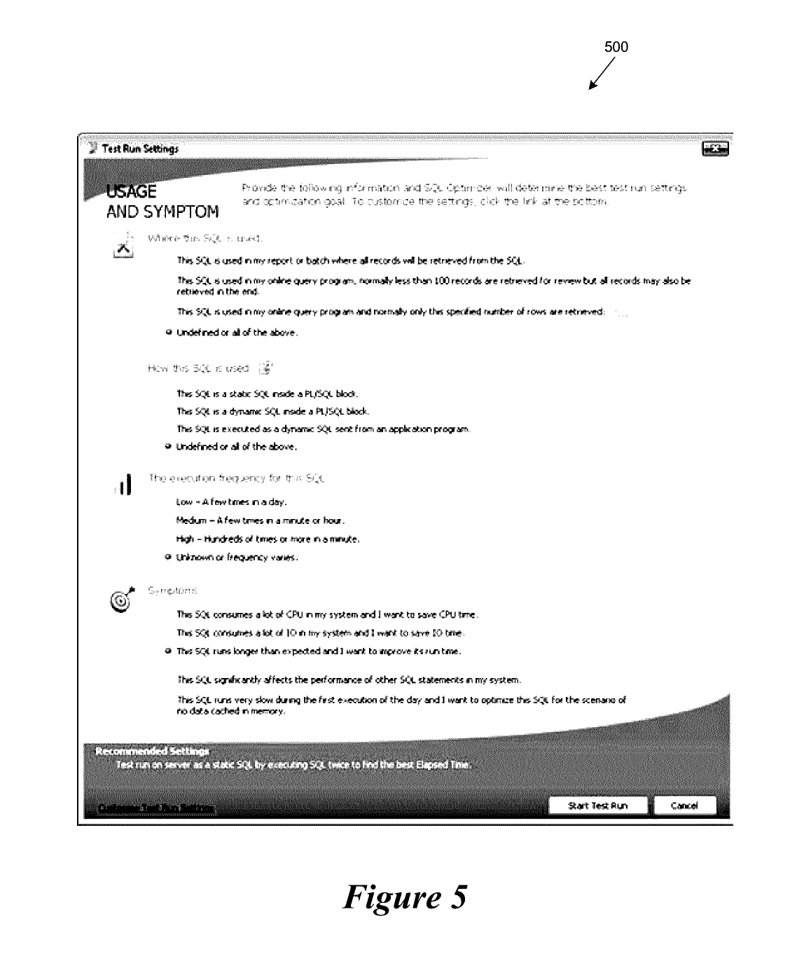

Referring to FIG. 5, an example screen presentation of the tuning tool user interface 500 is shown. More specifically, in certain embodiments, the SQL statement Usage and Symptom Oriented SQL Tuning tool user interface describes different possible usage patterns and symptoms the users may see in a SQL statement. These questions are directly related to the daily experience of the users so users can easily answer these questions without the need of knowing how the benchmark testing will be performed.

According to the answers to those questions in the tuning tool user interface 500, the expert system 310 is able to derive a set of test run options to use to conduct the benchmark. Users do not require knowledge of actual test run options that control how optimization and benchmarking work. The expert system automatically composes the best settings on behalf of users.

For example, one set of answers may include: 1. this SQL statement is used in my report or batch where ail records will be retrieved from the SQL statement, 2. this SQL statement is a static SQL statement inside a PL/SQL block, 3. execution frequency: Low—A few times a day, 4. this SQL statement runs longer than expected and I want to improve its run time, and 5. no symptoms are selected. The first answer indicates this SQL statement must retrieve all records, so benchmark of Elapsed Time is important, the second answer indicates that the tuning tool should benchmark the SQL statement in server side, the third answer indicates that the data of the SQL statement is probably not in memory cache, so the tuning toot will flush the BUFFER_CACHE before benchmarking each SQL statement alternative, the fourth answer corresponds to a dummy answer which is valid when a user doesn't know if the SQL statement is due to an IO or CPU problem, the fifth answer shows that no specific symptom is indicated. The result at step 450 to the benchmark method includes flushing the BUFFER_CACHE, executing all alternative SQL statements, and looking for lowest Elapsed Time SQL statement alternative.

In another example, another set of answers might include: 1. the SQL statement is used in my report or batch where all records wilt be retrieved from the SQL statement, 2. the SQL statement is a static SQL statement inside a PL/SQL block, 3. the execution frequency: Low—A few times a day, 4. the SQL statement runs longer than expected and want to improve its run time, 5. the SQL statement significantly affects the performance of other SQL statements in my system. The first answer indicates this SQL statement must retrieve all records, so benchmark of Elapsed Time is important, the second answer indicates that the tuning tool should benchmark the SQL statement on the server side, the third answer indicates that the data of this SQL statement is probably not in memory cache, so BUFFER_CACHE will be flushed before benchmarking each SQL statement alternative, the fourth answer is a dummy answer that is valid when user doesn't know if the SQL statement is of IO or CPU problem, and the fifth answer indicates that this SQL statement is running on parallel processing mode and occupying multiple CPU during execution, so the goal is to reduce the overall CPU usage instead of Elapsed Time. The result at step 450 includes flushing the BUFFER_CACHE, executing all alternative SQL statements, and looking for lowest CPU time SQL statement alternative.

In another example, another set of answers might include 1. the SQL statement is used in my online query program and normally only this specified number of rows are retrieved: 50, 2. the SQL statement is astatic SQL statement inside a PUSQL block, 3. the execution frequency: Low—A few times a day, 4. the SQL statement runs longer than expected and the user wishes to improve its run time, and 5. no symptom is selected. The first answer indicates that the SQL statement will normally return first 50 records only, so a SQL statement cursor can be used in benchmarking to retrieve 50 records and then the execution is terminated after the first 50 records are retrieved (Note: a Nested Loop join method will normally win out of all query plans), the second answer indicates that the system should benchmark the SQL system on the server side, the third answer indicates that the data of the SQL statement is probably not in memory cache, so BUFFER_CACHE will be flushed before benchmarking each SQL statement alternative, the fourth answer is a dummy answer that is valid when user doesn't know if the SQL statement is due to an IO or CPU problem and the fifth answer indicates that no specific symptom is indicated. The result at step 450 to these answers includes flushing BUFFER_CACHE, executing all alternative SQL statements, defining a SQL statement cursor to retrieve first 50 records only, and looking for lowest Elapsed Time SQL statement alternative.

By providing a usage and symptom driven approach, the SQL Statement Usage and Symptom Oriented Tuning Tool automatically connects a (problem to the solution for users. The tuning tool greatly reduces the effort and necessary knowledge from users by prompting users to provide easy, observable facts about the SQL statement operation. In this approach, the complexity of setting up test run options is removed. Users can define their problems directly. Complicated SQL statement tuning scenarios are turned into simplified questions without requiring users to have in-depth SQL statement tuning knowledge. As a result, users can quickly and efficiently identify the best solution for their specific SQL statement problem.

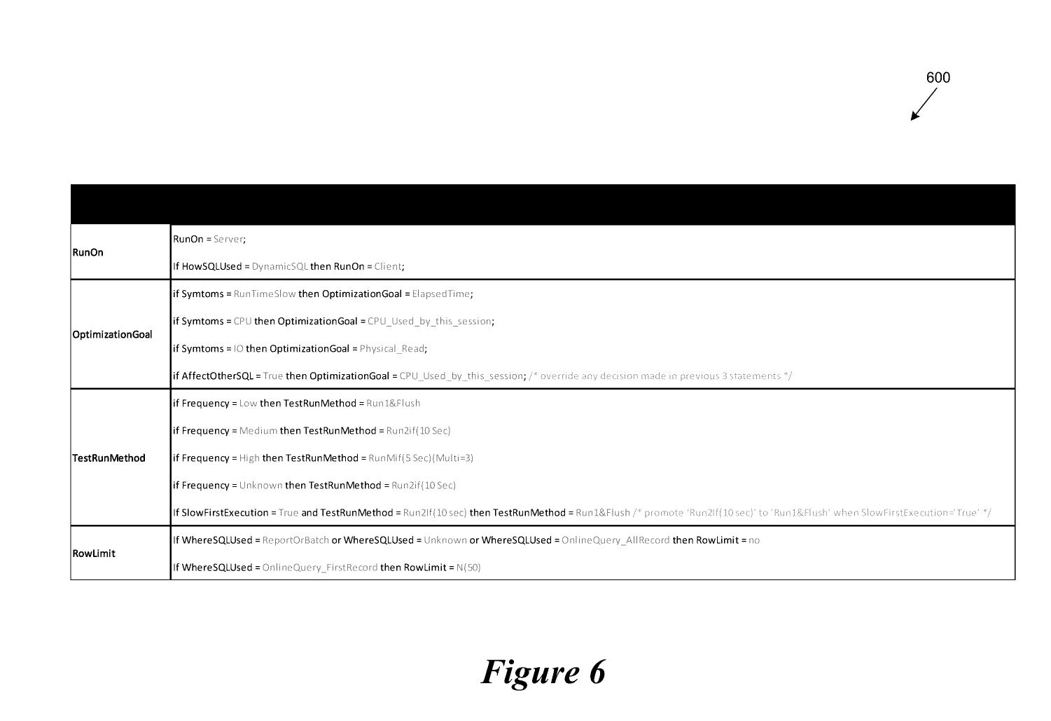

Referring to FIG. 6, a block diagram of rules of an expert system 600 of the SQL Statement Usage and Symptom Oriented Tuning Tool is shown. More specifically, the rules are executed in sequential order to address the answers to the questions provided by the user, where the latest changes override previous settings.

Each of the rules of the expert system 600 encapsulates a particular knowledge about how to handle a specific answer to the usage and symptom questions. Each rule makes up a part of the total solution and one rule may override the result of another rule. By visiting all rules, the expert system module 310 derives the best test run settings to address the user's problem.

As will be appreciated by one skilled in the art, the present invention may be embodied as a method, system, or computer program product. Accordingly, embodiments of the invention may be implemented entirely in hardware, entirely in software including firmware, resident software, micro-code, etc) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list; of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for providing usage and symptom oriented structured query language (SQL) optimization, comprising:
presenting a set of different possible usage patterns and symptoms to a user of a SQL statement;
defining symptoms to SQL statement problems based upon the set of different possible usage patterns presented to the user such that the user does not need to have knowledge of the actual settings used to tune the SQL statement to address an identified problem; and,
providing solutions to the SQL statement problems via a tuning tool, the tuning tool providing solutions without having the user translated the problems into options to be provided to a tuning and benchmarking system.

2. The method of claim 1, wherein:
the tuning tool comprises a SQL expert system.

3. The method of claim 2, wherein:
the SQL expert system interacts with a test matrix and a user interface when providing the solutions.

4. The method of claim 3, wherein:
the user interface allows users to provide the tuning tool with specific information about the performance symptoms and usage patterns of the SQL statement.

5. The method of claim 1, wherein:
the tuning tool analyzes where the SQL statement is used, when analyzing where the SQL statement is used, the SQL statement may be used in a report where all records are retrieved from the SQL statement, the SQL statement may be used in an online query program where normally less than 100 records are retrieved for review, but all records may also be retrieved, the SQL statement may be used in an online query program where normally only a specified number of rows are retrieved.

6. The method of claim 1, wherein:
the tuning tool analyzes how the SQL statement is used, when analyzing how the SQL statement is used, the SQL statement may be executed within a Procedural Language/Structured Query Language (PL/SQL) block, the SQL statement may be executed as a dynamic SQL statement sent from an application program or the answer may be undefined or all of the options.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
presenting a set of different possible usage patterns and symptoms to a user of a SQL statement;
defining symptoms to SQL statement problems based upon the set of different possible usage patterns presented to the user such that the user does not need to have knowledge of the actual settings used to tune the SQL statement to address an identified problem; and,
providing solutions to the SQL statement problems via a tuning tool, the tuning tool providing solutions without having the user translated the problems into options to be provided to a tuning and benchmarking system.

8. The system of claim 7, wherein:
the tuning tool comprises a SQL expert system.

9. The system of claim 7, wherein:
the SQL expert system interacts with a test matrix and a user interface when providing the solutions.

10. The system of claim 7, wherein:
the user interface allows users to provide the tuning tool with specific information about the performance symptoms and usage patterns of the SQL statement.

11. The system of claim 7, wherein:
the tuning tool analyzes where the SQL statement is used, when analyzing where the SQL statement is used, the SQL statement may be used in a report where all records are retrieved from the SQL statement, the SQL statement may be used in an online query program where normally less than 100 records are retrieved for review, but all records may also be retrieved, the SQL statement may be used in an online query program where normally only a specified number of rows are retrieved.

12. The system of claim 7, wherein:
the tuning tool analyzes how the SQL statement is used, when analyzing how the SQL statement is used, the SQL statement may be executed within a Procedural Language/Structured Query Language (PL/SQL) block, the SQL statement may be executed as a dynamic SQL statement sent from an application program or the answer may be undefined or all of the options.

13. A non-transitory, computer-readable storage medium embodying computer program code, the computer program code comprising computer executable instructions configured for:
presenting a set of different possible usage patterns and symptoms to a user of a SQL statement;
defining symptoms to SQL statement problems based upon the set of different possible usage patterns presented to the user such that the user does not need to have knowledge of the actual settings used to tune the SQL statement to address an identified problem; and,
providing solutions to the SQL statement problems via a tuning tool, the tuning tool providing solutions without having the user translated the problems into options to be provided to a tuning and benchmarking system.

14. The non-transitory, computer-readable storage medium of claim 13, wherein:
the tuning tool comprises a SQL expert system.

15. The non-transitory, computer-readable storage medium of claim 13, wherein:
the SQL expert system interacts with a test matrix and a user interface when providing the solutions.

16. The non-transitory, computer-readable storage medium of claim 13, wherein:
the user interface allows users to provide the tuning tool with specific information about the performance symptoms and usage patterns of the SQL statement.

17. The non-transitory, computer-readable storage medium of claim 13, wherein:
the tuning tool analyzes where the SQL statement is used, when analyzing where the SQL statement is used, the SQL statement may be used in a report where all records are retrieved from the SQL statement, the SQL statement may be used in an online query program where normally less than 100 records are retrieved for review, but all records may also be retrieved, the SQL statement may be used in an online query program where normally only a specified lumber of rows are retrieved.

18. The non-transitory, computer-readable storage medium of claim 13, wherein:
the tuning tool analyzes how the SQL statement is used, when analyzing how the SQL statement is used, the SQL statement may be executed within a Procedural Language/Structured Query Language (PL/SQL) block, the SQL statement may be executed as a dynamic SQL statement sent from an application program or the answer may be undefined or all of the options.
